(19) United States
(12) Patent Application Publication
(10) Pub. No.: US 2014/0082017 A1
(43) Pub. Date: Mar. 20, 2014

(54) SYSTEMS AND METHODS FOR ELECTRONICALLY DETERMINING OPERATION STATUS OF VEHICLES

(71) Applicant: Experian Information Solutions, Inc., (US)

(72) Inventor: Gerald Martin Miller, Cumming, GA (US)

(73) Assignee: Experian Information Solutions, Inc., Costa Mesa, CA (US)

(21) Appl. No.: 13/839,526

(22) Filed: Mar. 15, 2013

Related U.S. Application Data
(60) Provisional application No. 61/703,140, filed on Sep. 19, 2012.

(51) Int. Cl. G06F 17/30

(52) U.S. Cl. CPC G06F 17/30554
USPC 707/770

(57) ABSTRACT

In one embodiment, a vehicle operational status determination system receives a vehicle identification number (VIN) associated with a vehicle. Based on vehicle history data associated with vehicles, and further based on vehicle registration data regarding vehicles in a geographical area, the vehicle operational status determination system determines an operational status of a given vehicle in one of the plurality of the geographical areas.

### CROSS-REFERENCE TO RELATED APPLICATIONS

This application claims the benefit of priority under 35 U.S.C. §119(e) of U.S. Provisional Application No. 61/703,140, filed Sep. 19, 2012, the disclosure of which is hereby incorporated by reference in its entirety.

### BACKGROUND

1. Field

This disclosure generally relates to methods and systems for electronically determining whether, in a given geographical area, a given vehicle is or is not operational, and determining an overall count of vehicles in and/or out of operation in the given area, as well as associated parts for both types of vehicles.

2. Summary of the Disclosure

In one embodiment, a vehicle operational status determination system receives a vehicle identification number (VIN) associated with a vehicle. Based on vehicle history data associated with vehicles, and further based on vehicle registration data regarding vehicles in a geographical area, the vehicle operational status determination system determines an operational status of a given vehicle in one of the plurality of the geographical areas according to the vehicle's registration and history data.

### BRIEF DESCRIPTION OF THE DRAWINGS

FIG. 1 is a system diagram of an embodiment of a vehicle operational status determination system.

FIG. 2 illustrates an example user interface that provides a requesting entity with a summary count of vehicles of a given make, model and year in a plurality of given geographical areas.

FIG. 3 illustrates an example user interface that provides a requesting entity with a summary count of vehicle part types for different vehicle makes and models of a given year in a geographical area.

FIG. 4 illustrates an example user interface that provides a requesting entity with a summary count of engine types for different vehicles models and years of a given make, for a plurality of geographical areas.

FIG. 5 illustrates an example user interface that provides a requesting entity with a stocking guide listing a variety of tire sizes associated with vehicles in operation in a given geographical area.

FIG. 6 illustrates an example user interface that provides a requesting entity with an indication of percentages of vehicles out of operation by make, for a given geographical area.

FIG. 7 illustrates an example user interface that provides a requesting entity with an indication of a percentage of vehicles out of operation for a given vehicle model's different years.

FIG. 8 is a block diagram of a computer system for electronically determining whether a vehicle is in operation in a given geographical area.

### DETAILED DESCRIPTION

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

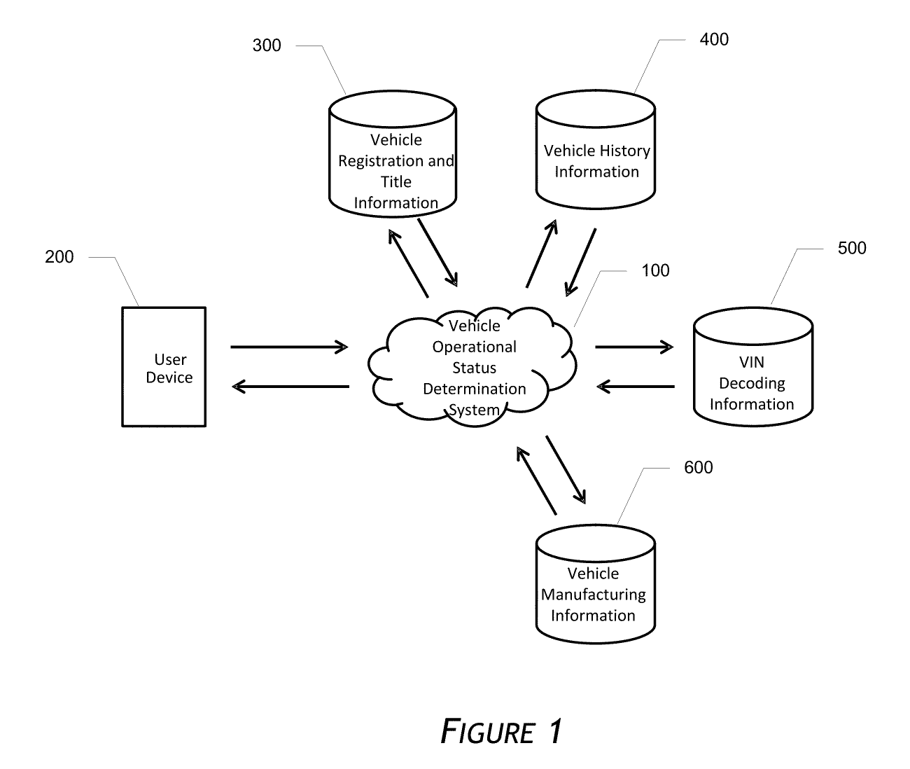

FIG. 1 is a system diagram of an embodiment of a vehicle operational status determination system. The vehicle operational status determination system 100 may be used to electronically determine whether a particular vehicle is or is not operational in a given geographical area. Manufacturers (such as, for example, vehicle manufacturers, as well as vehicle part manufacturers) and retailers (such as, for example, vehicle dealers and general retailers selling vehicle parts) depend on reliable data indicating the number of vehicles in use in different regions of the country to better conduct short and long-range planning.

For example, an accurate view of the number of vehicles operational and non-operational in a given region would help manufacturers and retailers to better manage parts portfolio and inventory levels, as well as to plan for service of the vehicles in the area. The inventory levels may be planned more efficiently for individual retail stores, as well as on an overall geographical area coverage basis (for example, inventory planning for a distribution center servicing several stores in a given area). The information may also be used to more efficiently plan for production of parts based on the number of vehicles in and out of operation. The information regarding vehicles in and out of operation in a given geographical area may also be useful for determining appropriate marketing strategies in the area. For example, the information may be used to determine the most popular vehicles in an area, and to target advertising accordingly. In addition, such information can help plan for new vehicle introductions and adjust for technology changes. The information can also help better assess locations for retail stores selling vehicle related products and services, as well as help assess locations for these such as service bays of vehicles. The information may also be useful for vehicle dealers' determination of which vehicles to offer for sale, and associated advertising strategies.

The vehicle operational status determination system 100 may receive information from a user device 200. The user may be a vehicle part manufacturer or retailer, or any other individual or entity interested in determining whether a vehicle is or is not, or a set of vehicles are or are not, operational in a given geographical area. The information received by the user device 200 can include one or several vehicle identification number(s) (VIN(s)).

The vehicle operational status determination system 100 may use the VIN(s) to determine the particular vehicles' operational status by using vehicle registration and title information 300 and vehicle history information 400. The vehicle registration and title information 300 and vehicle history information 400 may each be stored on one or more data storage media. Vehicle registration and title information 300 may include information relating to vehicle's registration status, including whether the vehicle has a registered title, the vehicle ownership, the operational status of the vehicle, and the like. Vehicle history information 400 may include information regarding the vehicle's past events, including but not limited to the vehicle's accident information, odometer information, maintenance information, service information, and the like.

In some embodiments, the vehicle registration and title information 300 may be obtained from various states' Department of Motor Vehicle (DMV). In various embodiments, data regarding the vehicle's registration obtained from vehicle registration and title information 300 may be used to determine whether the title and registration of a particular vehicle have been renewed. This determination may be used in conjunction with data regarding the particular vehicle's history, obtained from vehicle history information 400, to determine whether the same owner renewed the title and registration of the particular vehicle. Data regarding the particular vehicle's history obtained from vehicle history information 400 may also be used to determine whether the same owner renewed the title and registration of the particular vehicle in the same geographical location, or in different locations. Therefore, using information of a particular vehicle's owner or owners in possibly various locations over time, the vehicle operational status determination system 100 may consolidate the vehicle title and registration renewal information across different jurisdictions and thereby determine the operational status of the vehicle in a given area.

For example, even if a vehicle's registration is not renewed in one state, the vehicle operational status determination system 100 may use information from the vehicle history information 400 to determine that the title and registration were renewed by the same, or a different owner, in another state. Therefore, the vehicle operational status determination system 100 can accurately determine whether the vehicle is still operational. In particular, once a vehicle's title and registration renewal status is determined, for any possible location, then the vehicle operational status determination system 100 may make a determination regarding the vehicle's operational status, based on the title and registration renewal status. The vehicle operational status determination system 100 also determines that a given vehicle is no longer operational, using a similar process. For example, the vehicle operational status determination system 100 may determine that the vehicle title and registration has not been renewed in any state. Alternatively, the vehicle operational status determination system 100 may determine from the vehicle history information 400 that the vehicle does not have any maintenance records in any state.

The vehicle operational status determination system 100 may also use the VIN(s) received by the user device 200 to determine the subject vehicle's make, model and year. In some embodiments, this determination may be performed by using VIN decoding information 500. The VIN decoding information 500 may include one or more rules for determining a vehicle's make, model and year based on the vehicle's VIN. Once the vehicle's make, model and year are known, the vehicle operational status determination system 100 may use vehicle manufacturing information 400 to determine the total number of vehicles of the same make and model manufactured in that year. Using such information, the vehicle operational status determination system 100 may perform various calculations to determine the relative numbers, volumes or percentages of vehicles in or out of operation in a given geography as a function of the total number of vehicles of the same make and model manufactured in the year of interest. The information regarding the total number of vehicles of the same make and model manufactured in the year of interest may be obtained from the various manufacturers, or from other industry sources. In some embodiments, this information may be obtained from a data source such as vehicle manufacturing information 600.

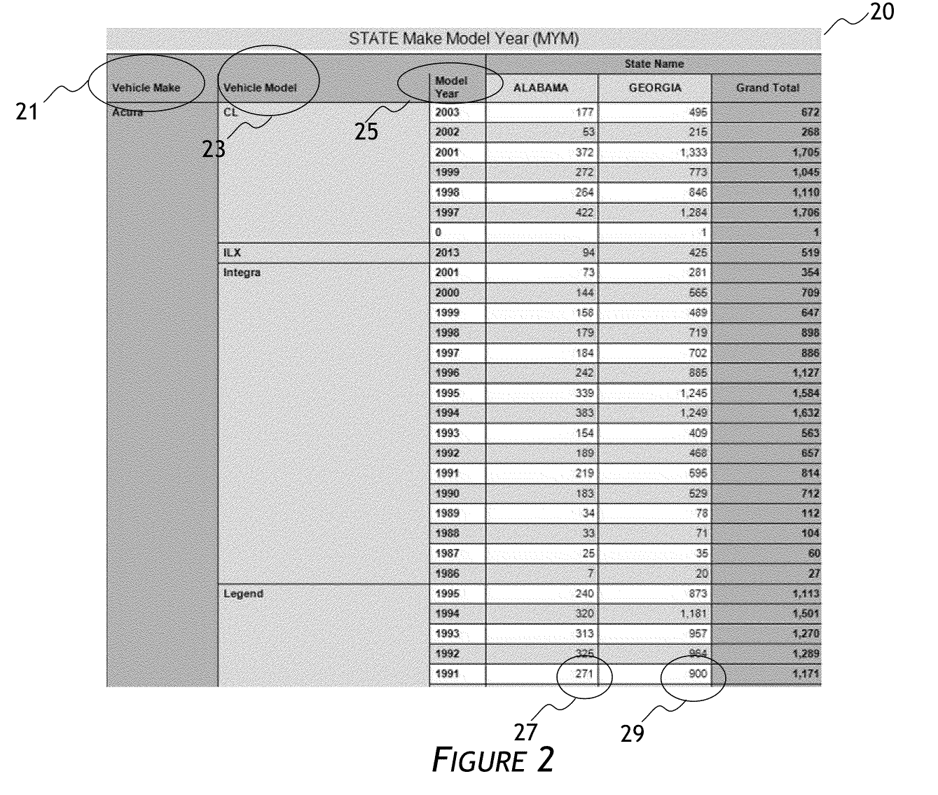

Once the operational status is determined, and the manufacturing information is ascertained, the vehicle operational status determination system 100 may return a report to the user device 200. An example of such a report is illustrated in FIG. 2. The example report shown in FIG. 2 includes a count of operational vehicles for given vehicle makes 21, models 23 and years 25 in two different geographical areas. For example, for the vehicle make Acura, model Legend and year 1991, the report indicates a count 27 of 271 vehicles operational in Alabama and a count 29 of 900 vehicles operational in Georgia. From this information, a parts manufacturer or retailer may determine that Georgia may be a better market for stocking parts for the 1991 model of Acura Legend.

In other embodiments, the report may include the status of operation for the vehicle(s) (such as for example, in or out of operation), as well as some details of vehicles of similar make, model and year as the vehicle(s) for which VIN(s) were received. The report may also include information regarding the current location of use of the vehicle, if the vehicle is in use, or the last location of use, if the vehicle is not currently in use. Additionally, the report may also include vehicle population changes to a geographical area, vehicle parts (such as, for example, tires, batteries, brakes, spark plugs, and the like) population or population changes associated with the vehicles in or out of operation within a geographical area. Information regarding parts associated with various vehicles may be obtained from a variety of sources, including, for example, the vehicle manufacturing information 600, the vehicle history information 400, or other sources.

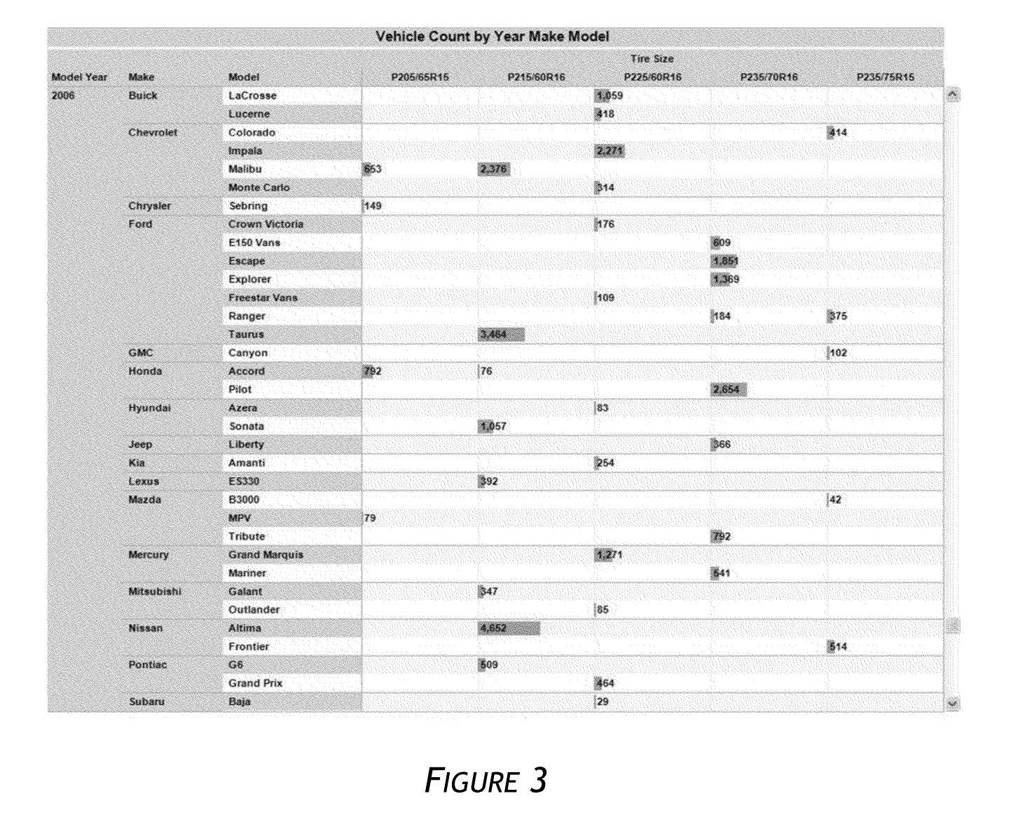

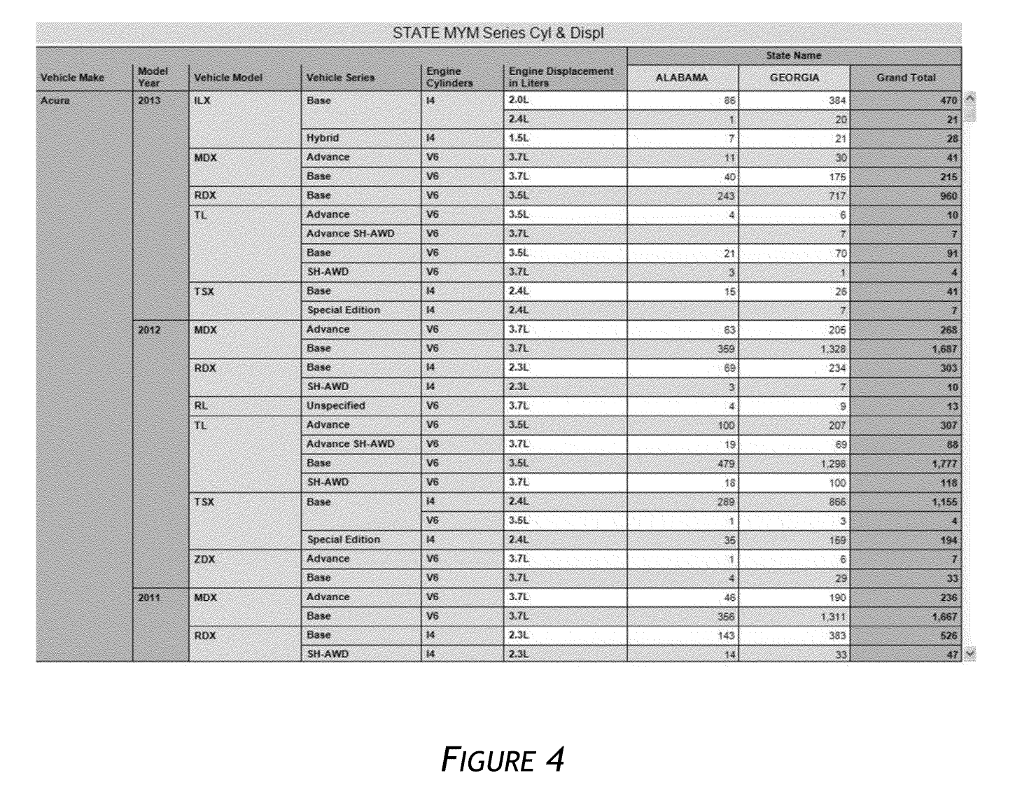

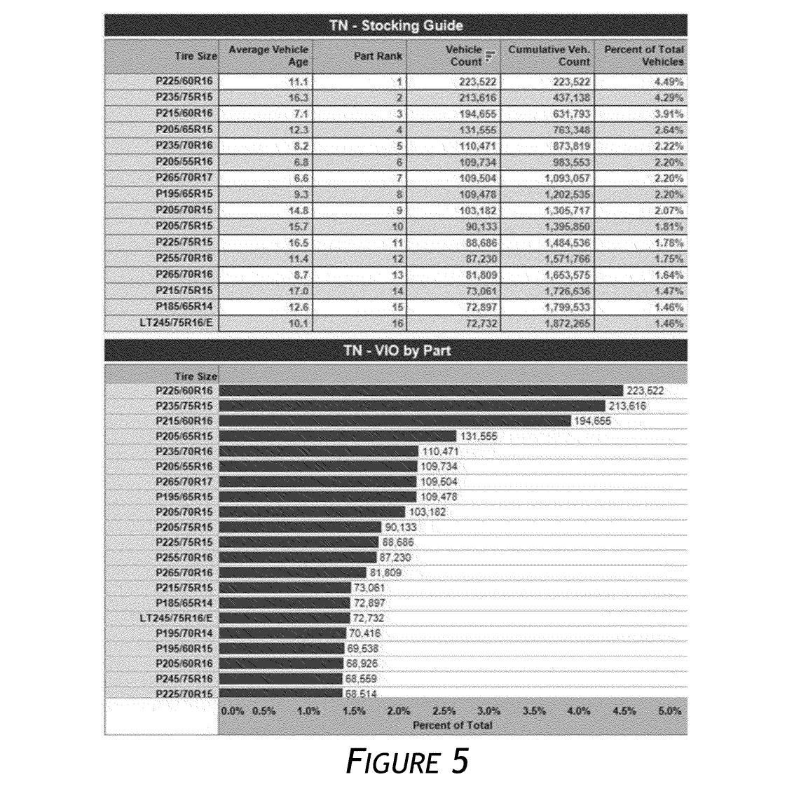

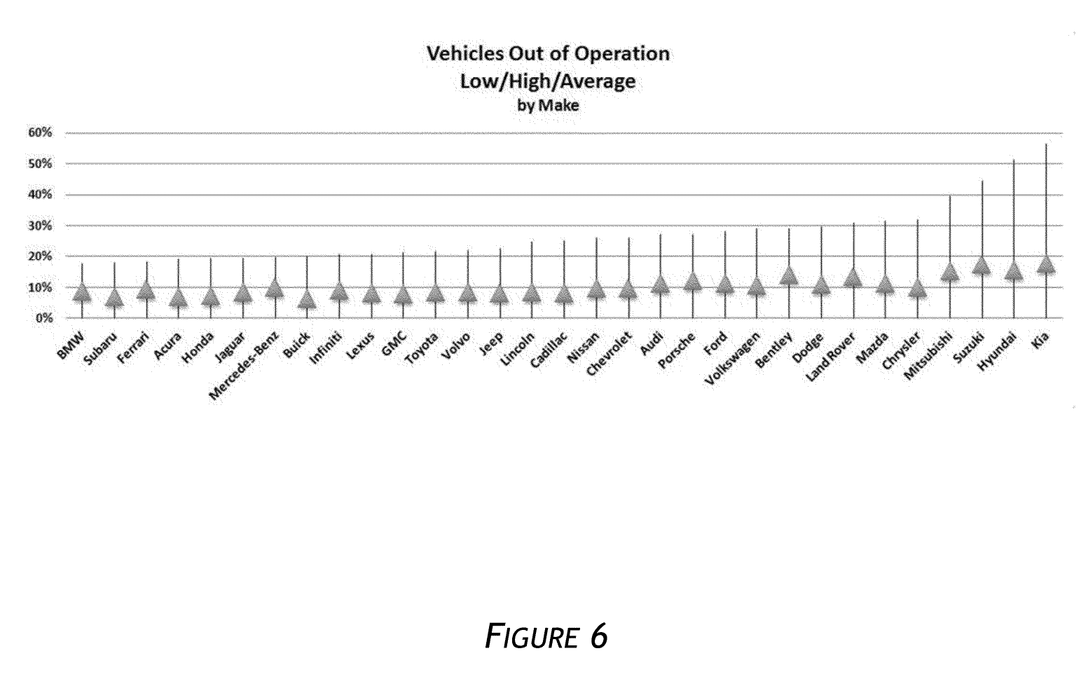

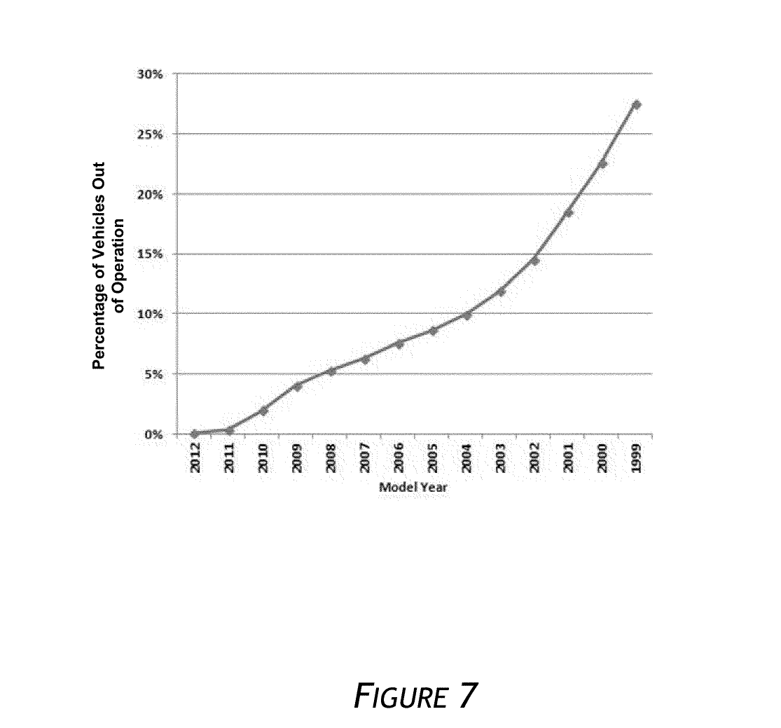

Other example reports are provided in FIGS. 3-7. FIG. 3 illustrates an example user interface that provides a requesting entity with a summary count of vehicle part types for different vehicle makes and models of a given year in a geographical area. FIG. 4 illustrates an example user interface that provides a requesting entity with a summary count of engine types for different vehicles models and years of a given make, for a plurality of geographical areas. FIG. 5 illustrates an example user interface that provides a requesting entity with a stocking guide listing a variety of tire sizes associated with vehicles in operation in a given geographical area. The figure also shows that parts may be ranked in accordance with the vehicle count in a given area, and/or in accordance with the percentage of vehicles requiring the part in question in relation to all vehicles in a given area. FIG. 6 illustrates an example user interface that provides a requesting entity with an indication of percentages of vehicles out of operation by make, for a given geographical area. The percentages may be used to rank various vehicle makes and models relative to one another on a scale. For example, threshold percentages may be selected to categorize a given vehicle make and model as having a low likelihood, a high likelihood, or an average likelihood of being out of operation. FIG. 7 illustrates an example user interface that provides a requesting entity with an indication of a percentage of vehicles out of operation for a given vehicle model's different years.

### Computing System

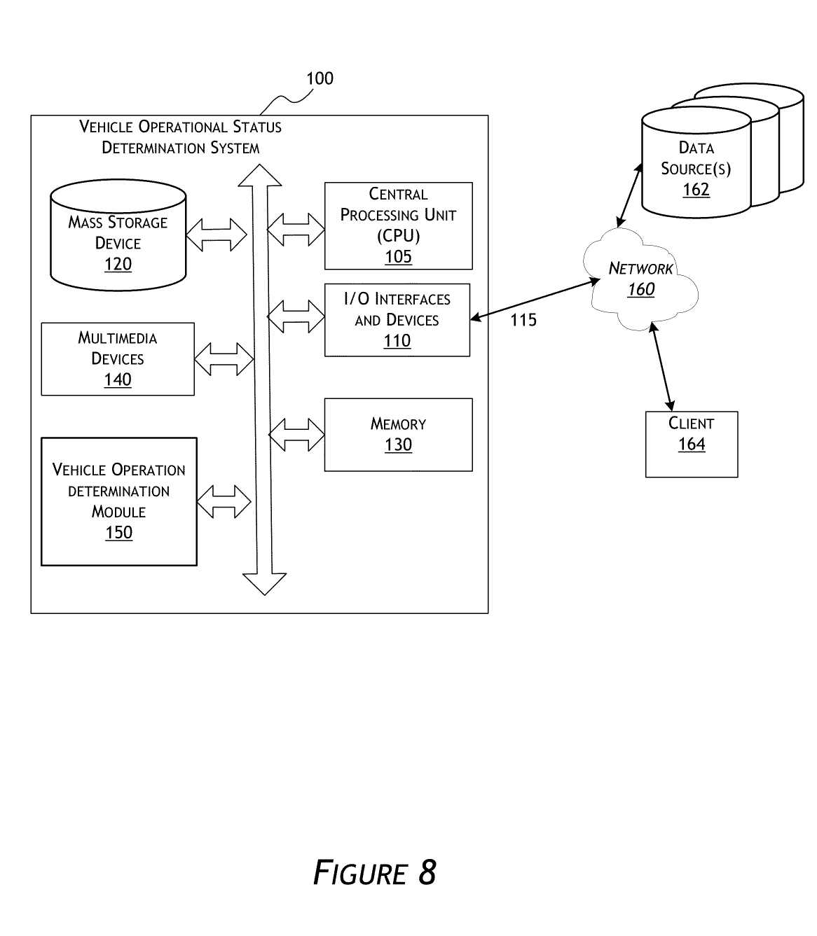

In some embodiments, the systems, computer clients and/or servers described above take the form of a computing system as shown in FIG. 8. FIG. 8 is a block diagram showing an embodiment in which vehicle operational status determination system 100 is in communication with a network 160 and various systems are also in communication with the network 160. The vehicle operational status determination system 100 may be used to implement systems and methods described herein. For example, the vehicle operational status determination system 100 may be configured to receive a vehicle's VIN from a user, and to determine the vehicle's operational status. In some embodiments, the system 100 is accessed remotely by the client 164, the system 100 is local to the client 164, and/or a combination of the two. In addition to supplying data, client 164 may further request information from the vehicle operational status determination system 100. In some embodiments, the client 164 may include a user device 200.

The vehicle operational status determination system 100 includes, for example, a personal computer that is IBM, Macintosh, or Linux/Unix compatible. In one embodiment, the vehicle operational status determination system 100 comprises a server, a laptop computer, a cell phone, a personal digital assistant, a kiosk, or an audio player, for example. In one embodiment, the vehicle operational status determination system 100 includes a central processing unit (“CPU”) 105, which may include a conventional microprocessor. The vehicle operational status determination system 100 further includes a memory 130, such as random access memory (“RAM”) for temporary storage of information and a read only memory (“ROM”) for permanent storage of information, and a mass storage device 120, such as a hard drive, diskette, or optical media storage device. Typically, the modules of the vehicle operational status determination system 100 are connected to the computer using a standard based bus system. In different embodiments, the standard based bus system could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of vehicle operational status determination system 100 may be combined into fewer components and modules or further separated into additional components and modules.

The vehicle operational status determination system 100 is generally controlled and coordinated by operating system software, such as Windows 95, Windows 98, Windows NT, Windows 2000, Windows XP, Windows Vista, Unix, Linux, SunOS, Solaris, or other compatible operating systems. In Macintosh systems, the operating system may be any available operating system, such as MAC OS X. In other embodiments, the vehicle operational status determination system 100 may be controlled by a proprietary operating system. Conventional operating systems control and schedule computer processes for execution, perform memory management, provide file system, networking, I/O services, and provide a user interface, such as a graphical user interface (“GUI”), among other things.

The vehicle operational status determination system 100 includes one or more commonly available input/output (I/O) devices and interfaces 110, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The vehicle operational status determination system 100 may also include one or more multimedia devices 140, such as speakers, video cards, graphics accelerators, and microphones, for example.

In the embodiment of FIG. 8, the I/O devices and interfaces 110 provide a communication interface to various external devices. In the embodiment of FIG. 8, the vehicle operational status determination system 100 is electronically coupled to a network 160, which comprises one or more of a LAN, WAN, or the Internet, for example, via a wired, wireless, or combination of wired and wireless, communication link 115. The network 160 communicates with various computing devices and/or other electronic devices via wired or wireless communication links.

According to FIG. 8, information is provided to the vehicle operational status determination system 100 over the network 160 from one or more data sources 162. The data sources 162 may include one or more of vehicle registration information 300, vehicle history information 400, VIN decoding information 500 and vehicle manufacturing information 600. In addition to the devices that are illustrated in FIG. 8, the network 160 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In the embodiment of FIG. 8, the vehicle operational status determination system 100 also includes a vehicle operation determination module 150, which may each be executed by the CPU 105. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment shown in FIG. 8, the vehicle operational status determination system 100 is configured to execute vehicle operation determination module 150, among others, in order to electronically determine the operational status of vehicles. In some embodiments, the vehicle operation determination module 150 may be configured to obtain data from data source(s) 162.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

It is recognized that the term “remote” may include data, objects, devices, components, and/or modules not stored locally, that is not accessible via the local bus. Thus, remote data may include a device which is physically stored in the same room and connected to the computing system via a network. In other situations, a remote device may also be located in a separate geographic area, such as, for example, in a different location, country, and so forth.

### Additional Embodiments

All of the processes described above may be embodied in, and fully automated via, software code modules executed by one or more general purpose computers. The code module may be stored in any type of computer-readable medium or other computer storage device. Some or all of the methods may alternatively be embodied in specialized computer hardware. As will be apparent, the features, and attributes of the specific embodiments disclosed above may be combined in different ways to form additional embodiments, all of which are fall within the scope of the present disclosure. Although this disclosure has been described in terms of certain preferred embodiments and applications, other embodiments and applications that are apparent to those of ordinary skill in the art, including embodiments which do not provide all of the features and advantages set forth herein, are also within the scope of this disclosure.

What is claimed is:

1. A system for electronically determining whether a vehicle is operational or not, the system comprising:
a first data store that stores a plurality of records comprising vehicle history data associated with vehicles;
a second data store that stores a plurality of records comprising vehicle registration data regarding vehicles in a geographical area; and
a computing device that is in communication with the first and second data stores and that is operative to:
receive, from a user computing device, a vehicle identification number (VIN) associated with a vehicle;
receive, from the first data store, vehicle history data associated with the vehicle, wherein the vehicle history data includes at least a current and a past owner of the vehicle;
receive, from the second data store, for a plurality of geographical areas, registration data regarding the vehicle for at least one of the plurality of geographical areas; and
determine an operational status of the vehicle in one of the plurality of the geographical areas according to the vehicle's registration and history data.

2. The system of claim 1, wherein the computing device is further operative to determine a manufacturer of the vehicle based on the VIN received.

3. The system of claim 2, wherein the computing device is further operative to determine a number of vehicles sold by the manufacturer of the vehicle in the geographical area.

4. The system of claim 3, wherein the computing device is further operative to determine a number of sold vehicles in the geographical areas that are operational.

5. The system of claim 1, wherein the computing device is further operative to evaluate the operational status of the vehicle in the plurality of the geographical areas.

6. The system of claim 1, wherein the computing device is further operative to determine at least one of a make, a model and a year associated with the vehicle based on the VIN associated with the vehicle.

7. The system of claim 6, wherein the computing device is further operative to receive vehicle parts information regarding vehicles.

8. The system of claim 7, wherein the computing device is further operative to determine an indication of types of vehicle parts in the given geographical area.

9. The system of claim 7, wherein the computing device is further operative to determine an indication of a count of vehicle parts in the given geographical area.

10. A computer-implemented method for electronically determining whether a vehicle is operational or not, the method comprising:
receiving a vehicle identification number (VIN) associated with a vehicle;
receiving, from a first data store that stores a plurality of records comprising vehicle history data associated with vehicles, vehicle history data associated with a vehicle, wherein the vehicle history data includes at least a current and a past owner of the vehicle;
receiving, from a second data store that stores a plurality of records comprising vehicle registration data regarding vehicles in a geographical area, for a plurality of geographical areas, registration data regarding the vehicle for at least one of the plurality of geographical areas; and
determining an operational status of the vehicle in one of the plurality of geographical areas according to the vehicle's registration and history data.

11. The computer-implemented method of claim 10, further comprising determining a manufacturer of the vehicle based on the VIN received.

12. The computer-implemented method of claim 11, further comprising determining a number of vehicles sold by the manufacturer of the vehicle in the geographical area.

13. The computer-implemented method of claim 12, further comprising determining a number of sold vehicles in the geographical areas that are operational.

14. The computer-implemented method of claim 11, further comprising evaluating the operational status of the vehicle in the plurality of geographical areas.

15. The computer-implemented method of claim 10, further comprising determining at least one of a make, a model and a year associated with the vehicle based on the VIN associated with the vehicle.

16. The computer-implemented method of claim 15, further comprising receiving vehicle parts information regarding vehicles.

17. The computer-implemented method of claim 16, further comprising determining an indication of types of vehicle parts in the given geographical area.

18. The computer-implemented method of claim 16, further comprising determining an indication of a count of vehicle parts in the given geographical area.
